(19) United States
(12) Patent Application Publication
(10) Pub. No.: US 2005/0128520 A1
(43) Pub. Date: Jun. 16, 2005

(54) Digital signature protection for software

(76) Inventor: Jeff Glickman, Las Vegas, NV (US)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 11/012,983

(22) Filed: Dec. 14, 2004

Related U.S. Application Data
(60) Provisional application No. 60/530,471, filed on Dec. 16, 2003.

(51) Int. Cl. G06F 15/00

(52) U.S. Cl. 358/1.15

(57) ABSTRACT

The present disclosure provides a method of securing transmission of a software dispatch. The method may include receiving a software dispatch with a digital signature, decrypting the digital signature, and validating the digital signature. If the digital signature is valid, the method may further include accepting the software dispatch.

### CROSS-REFERENCE TO RELATED APPLICATION

The present application claims priority from U.S. Provisional Patent Application Ser. No. 60/530,471 filed Dec. 16, 2003, hereby incorporated by reference in its entirety for all purposes.

### TECHNICAL FIELD

The present disclosure relates generally to apparatus, systems and methods for securing data, and more specifically, to apparatus, systems and methods for securing software transmission.

### BRIEF DESCRIPTION OF THE DRAWINGS

The disclosure is illustrated by way of example and not by way of limitation in the figures of the accompanying drawings, in which the like references indicate similar elements and in which:

FIG. 1 is a schematic diagram of an image-processing system according to an embodiment of the present disclosure.

FIG. 2 is a schematic diagram of a transmission of a dispatch over a wireless network from an image source to an image display system according to an embodiment of the present disclosure.

FIG. 3 is a schematic diagram of a method of authenticating and securing a dispatch over the network shown in FIG. 2.

FIG. 4 is a schematic diagram of transmission of a software upgrade with a digital signature to an image display system according to an embodiment of the present disclosure.

### DETAILED DESCRIPTION

Generally, methods, systems and apparatus for securing transmission of a software dispatch are disclosed herein. For example, in one embodiment, described in more detail below, the method may include wirelessly receiving a software dispatch with a digital signature, decrypting the digital signature and validating the digital signature. If the digital signature is valid, the method may further include accepting the software dispatch.

As background, image display devices, such as image projectors, televisions, and the like, have become popular tools for both personal and business purposes. For example, image display devices may be used to project one or more images, such as data images or video images, onto a viewing surface.

Some image display devices are configured to enable a user to transmit images from a computer to the image display device. In some systems, a user must physically connect their computer, such as a personal computer, to the image display device. This process may be cumbersome and frustrating to a presenter. For example, there may be compatibility issues between the hardware and software on the computer and the image display device. Moreover, connection to the image display device may require numerous cables and/or adapters to enable connection of the user's computer with the available image display device. It is not unusual for the cables and adapters to get lost or become misplaced.

Wirelessly connecting the image display device or system to a computer may eliminate some of the frustrations that may arise when attempting to physically connect a computer to an image display device. However, the security of a transmission between the image display device/system and the computer may be of some concern. Third parties may be able to interrupt or intercept transmissions between a computer and an image display device/system. Moreover, the downloading of software and/or software updates to the image display device/system or associated device over a wireless network may produce additional security risks. For example, unauthorized software downloaded to an image display device may introduce undesired and foreign programs to the image display device. The unauthorized software may include worms, viruses, Trojan horses, etc. which may affect the performance of the image display device.

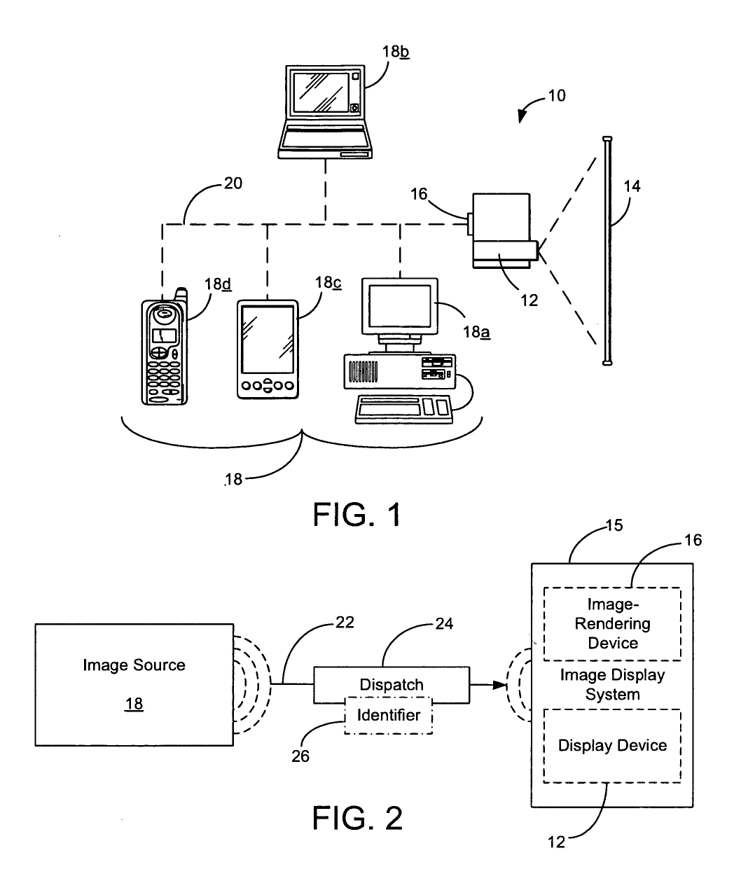

Referring initially to FIG. 1, an image-processing system is shown generally at 10 according to an embodiment of the present disclosure. Image-processing system 10 includes an image display device 12. Image display device 12 may be configured to display an image on a viewing surface 14. For example, image display device 12 may be a projection device or image projector 12. Further, image display device 12 may be any suitable type of image display device adapted to project a video or data image. Examples include, but are not limited to, liquid crystal display (LCD) devices, digital light processing (DLP) projectors and devices, rear display devices, rear projection devices, front display devices, front projection devices, televisions, etc. Furthermore, it will be appreciated that image display device 12 may be incorporated within other types of display systems, including, but not limited to, television systems, computer monitors, or other image display systems.

The image display device within image-processing system 10 may also include an image-rendering device 16. Image-rendering device 16 may be associated with image display device 12, and one or more image sources 18 in electrical communication with image-rendering device 16. Image-rendering device 16 may be configured to receive image data transmitted by image sources 18, and to render the received image data for display by image display device 12. It should be appreciated that image data may be any displayable images, including video images, still images, text, data images, etc.

Image-rendering device 16 may be integrated into image display device 12, or may be provided as a separate component that is connectable to the image display device. An example of a one type of image-rendering device is disclosed in U.S. patent application Ser. No. 10/453,905, filed on Jun. 2, 2003, the disclosure which is hereby incorporated by reference.

In some embodiments, image-rendering device may be adapted to receive a data transfer device that may enable image-rendering device 16 to receive images from image sources 18. Any suitable data transfer device may be coupled with or integrated within image-rendering device 16. For example, the data transfer device may be a card, an expansion board, an adapter or other suitable device. More specifically, the data transfer device may be a network interface card, such as a wireless network card, such as wireless LAN card, such as IEEE 802.11a, 802.11b, 802.11g, 802.11x, a radio card, a Bluetooth radio card, a ZigBee radio, etc. In some embodiments, the data transfer device may further include or be interchanged with a wired network card, such as an IEEE 802.3 standard wired local area network (LAN) interface card, e.g. Ethernet, 100BASE-T standard (IEEE 802.3u) or fast Ethernet, IEEE 802.3z or gigabit Ethernet, and/or other suitable wired network interface.

The data transfer device may enable communication and image data transmission from an image source 18 to image-rendering device 16. Image sources 18 may include any suitable device that is capable of providing image data to image-rendering device 16. Examples of image sources include, but are not limited to, desktop computers and/or servers 18a, laptop computers 18b, personal digital assistants (PDAs) 18c, mobile telephones 18d, etc.

Furthermore, image sources 18 may communicate electrically with image-rendering device 16 in any suitable manner. In the depicted embodiment, each image source 18 may be configured to communicate electrically with image-rendering device 16 over a communication link, such as a wireless network 20. However, one or more image sources 18 may also communicate with image-rendering device 16 over a wired network, or over a wireless or wired direct connection.

Image sources 18 may be configured to provide any suitable type of image data to image-rendering device 16, for example, JPEG, MPEG and other pre-compressed files. Alternatively or additionally, image sources 18 may be configured to generate raw data files from images displayed on a screen of the image source, and then to compress the files using a fast compression technique, such as an LZO compression technique, for transmission to image-rendering device 16 in real-time. This allows any image displayed on a screen of an image source 18 (or any raw data file on an image source 18) to be transmitted to and displayed by image display device 12.

FIG. 2 further illustrates the communication link between an image source 18 and an image display system 15. Image display system 15 may include image display device 12 and image-rendering device 16. In some embodiments, image-rendering device 16 may be incorporated within image display device 12. The exemplary communication link may be a wireless channel 22. The wireless channel may enable linkage to a local area wireless network (LAN) or other suitable network.

As illustrated, image source 18 may transmit a dispatch 24 over wireless channel 22 to image display system 15. Dispatch 24 may be image data or software, such as software for updating or changing the function and/or performance of image display system 15. Software, as used herein, may be executable code or instructions. Such software may be systems software or applications software.

In some situations, there may be a reasonable apprehension regarding the security of the wireless channel. For example, a user may be reluctant to transmit data from a personal image source over a wireless channel due to the fear that the data may be potentially intercepted by a third party source. By providing security over the wireless channel, users can ensure uninterrupted delivery of dispatches. As discussed in more detail below, wireless channel 22 may be secured using any suitable wireless channel security system. For example, wireless channel 22 may be protected by use of cryptosystems, systems as the Advanced Encryption Standard (AES) cryptosystem. It should be appreciated that other suitable cryptosystems may be used alone, or in combination, to secure the wireless channel.

In addition to apprehension regarding the security of the wireless channel, there may be apprehension regarding the transmission of software and like programs to the image display system. For example, a user and/or a manufacturer may be concerned regarding the transmission of corrupt software dispatches to the image display system. A corrupt software dispatch, as used herein, includes any unauthorized software or like program introduced to the image display system via the communication link. The corrupt software dispatch may be unauthorized software upgrades, and/or modifications to the authorized software or software upgrades. The corrupt software dispatches may include viruses, worms, etc. and may affect the performance of the image display system.

As described in more detail below, a marker, such as identifier 26, may be used to identify authorized software dispatches. A software dispatch may include new software, software upgrades, etc. for use in a receiving system, such as an image display system. The image display system may be configured to recognize the identifier, accepting software dispatches with a valid identifier and rejecting software dispatches which do not carry the identifier or which carry an inaccurate or invalid identifier. Thus, submission of a corrupt dispatch to an image display system may result in rejection of the dispatch by the image display system. Moreover, interception and modification of an authorized software upgrade by a third party may result in a change in the identifier. The altered identifier may be recognized as an invalid identifier, preventing the acceptance of modified software upgrades into the image display system. As discussed in more detail below, embodiments of the present disclosure include methods for providing an identifier 26 on authorized dispatches and configuring the image display system to recognize identifier 26, thus substantially eliminating the acceptance of corrupt software dispatches into the receiving system.

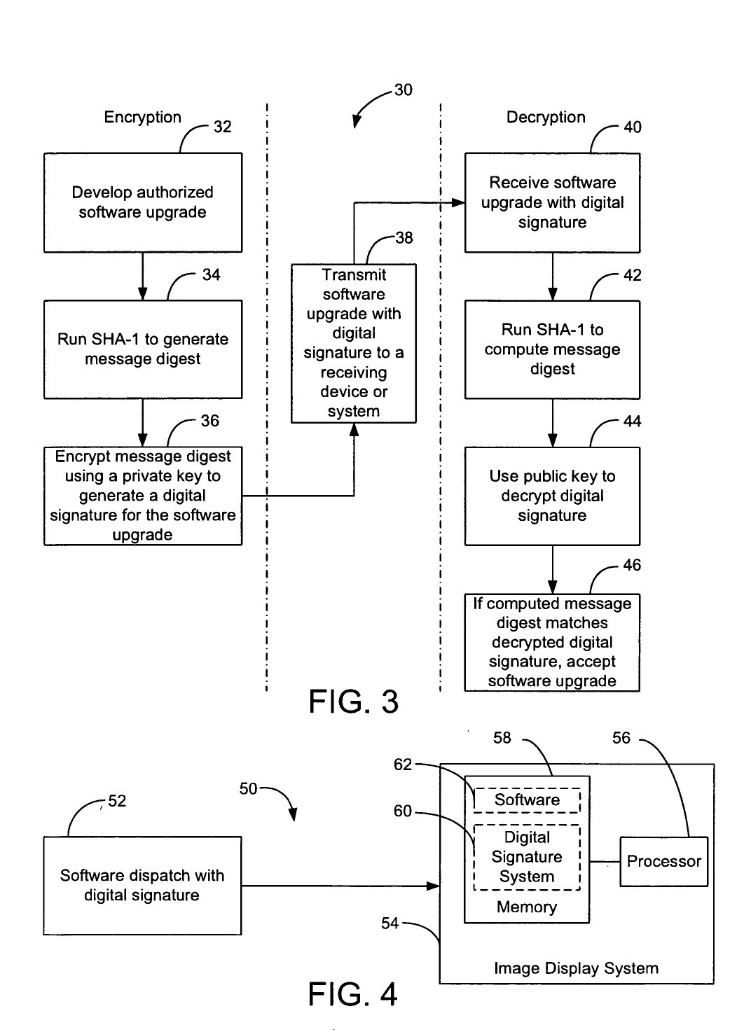

FIG. 3 illustrates one method, indicated generally at 30, of providing a secure identifier for an authorized software dispatch. It should be appreciated that other suitable methods may be used to create secure identifiers for dispatches. Generally, the method includes receiving a software upgrade with a digital signature, decrypting the digital signature, validating the digital signature, and accepting the software upgrade where the digital signature is valid. Although described in relationship to a software upgrade for an image display system, it should be appreciated that such a method may be used to transmit software upgrades (or like programs) to other suitable electronic devices and systems.

Specifically, in FIG. 3, the software dispatch may include an encrypted portion. The encrypted portion of the software dispatch may be decrypted by the image display system to identify the software dispatch as an authorized, unmodified software dispatch. Although FIG. 3 illustrates the use of an asymmetric encryption/decryption process, it should be appreciated that other methods may be used.

In the asymmetric encryption/decryption illustrated in FIG. 3, two keys are used—a private key and a public key. Each key has a different value. In the illustrated method, encryption is performed using the private key and decryption is performed using the public key.

Briefly, in one embodiment of the present disclosure, a method of securing a software upgrade is provided. As described in more detail below, the method may include generating a digital signature for the software upgrade using a private key, distributing the software upgrade to a user, and supplying a public key for use in decrypting the digital signature. The private key may be retained in the control of a distributor/manufacturer, etc. The public key may substantially correspond to the private key and may be available to users of the device (such as an image display system) receiving the software upgrade.

For example, in some embodiments, initially, a manufacturer or developer may develop authorized software or software upgrades for an image display system, as indicated at 32. Such software may relate to the operation and/or the function of the image display system, including the operation and function of the image display device and/or the image-rendering device. In some embodiments, the software may provide new functions and/or operations; alternatively, the software may update or improve earlier functions and/or operations. Although described in regards to transmission of a software upgrade, the method may be applied to any software or program that a user wants to transmit to the image display device. The method may further be applied to any data transmission by the user, such as a video transmission, data transmission, etc. Regardless of the type of dispatch, the use of the method enables confirmation that a received transmission (or dispatch) originated from a particular source and was not corrupted during transmission.

In the disclosed method, an authorizer or authenticator (such as an approved manufacturer or developer for the software upgrade) may run a secure hash algorithm, such as the standard secure hash algorithm (SHA-1) as defined by the National Institute of Standards of the U.S. Department of Commerce in FIPS Publication No. 180-1, on the software upgrade. The secure hash algorithm may be used to generate a condensed representation of a message or a message digest, as shown at 34. The generated message digest may be a string of characters correlated with the dispatch that may be encrypted to form a digital signature.

SHA-1 may be an appropriate algorithm to generate a message digest for the wireless transmission because it is generally considered to be computationally infeasible to find a message which corresponds to a given message digest, or to find two different messages which produce the same message digest when using SHA-1. Any change to a message in transit will, with very high probability, result in a different message digest, and the signature will fail to verify. As discussed below, SHA-1 may be used as both the transmitter and receiver of a message, thus both computing and verifying the digital signature. Although the disclosed method is described in regards to the use of SHA-1, it should be appreciated that other types of coding algorithms may be used to generate a message digest or similar authentication code.

The generated message digest may be encrypted using a private key, shown at 36. A private key, as used herein, is a private key algorithm held by the authorizer and/or authenticator. The private key may be retained within the control of the authorizer/authenticator and may not be available without permission from such authorizer/authenticator. Encrypting the message digest with the private key results in generation of a digital signature. The digital signature is a unique value and operates as the identifier described in FIG. 2.

It should be noted that the private key may be secured within the authenticator's or authorizer's place of business. Thus, the private key may be maintained separate from the general public. For example, the private key may be contained within a secure room in an approved manufacturer's place of business. Prior to release of software, a manufacturer or approved authenticator may generate a digital signature for the software by encrypting the message digest using the above-described private key. It should be appreciated that the above encryption may be accomplished using any suitable encryption device, including, but not limited to, a private computer, a network computer, a personal computer, etc.

Once the digital signature is generated, the software upgrade (or software) and digital signature may be transmitted via a communication link (such as a wireless network) to a receiving device or system, as indicated at 38. For example, a user may purchase or otherwise obtain an authorized software upgrade from a manufacturer. The software may include a pre-generated digital signature. Transmission of the software from a user's computer or other device (transmission device) to a receiving device, such as an image display system, includes transmission of the digital signature created by the manufacturer.

The image display system, i.e., the image-rendering device and/or image display device, may be configured to receive the software upgrade with digital signature, at 40. The image-rendering device may use SHA-1, or similar algorithm, to compute a message digest, at 42. The message digest may be considered a comparative message digest for the software upgrade and may be used to determine whether the digital signature accompanying the software upgrade is authentic.

In addition to computing the comparative message digest, the image-rendering device further uses a public key to decrypt the digital signature received with the software upgrade, at 44. Decrypting the digital signature results in a decrypted message digest. It should be appreciated that any suitable type of public key that corresponds to the private key used for encryption may be used. For example, in some embodiments, an RSA public key (developed by RSA Data Security, Inc.) may be used, however other public keys may be used without departing from the scope of the disclosure. The public key does not provide information regarding the private key.

If the computed or comparative message digest matches the decrypted digital signature (message digest prior to encryption), the digital signature may be considered a valid digital signature. Upon validating the digital signature, the software upgrade may be accepted by the image display system as an authentic unmodified software upgrade, as indicated at 46. The authentic upgrade may be introduced or loaded into the image display system, updating software within the image-rendering device and/or image display device. It should be appreciated that if the computed message digest does not match the decrypted digital signature, the digital signature is not recognized as a valid digital signature. In such a situation, the software upgrade may be rejected by the image display system as potentially being a corrupted dispatch.

The use of the asymmetric key substantially prevents compromise of the system even if the memory of the image display system has been attacked. For example, with use of the asymmetric key system, a third party who locates the decryption key in the memory of the image display system will still be unable to create and sign a dispatch that the image display system will accept since the encryption and decryption keys are different. Although a method using an asymmetric operation, incorporating the use of two different keys, is described above, it should be appreciated that other suitable methods may be used.

It should be noted that in some embodiments digital certificates may be provided with the software upgrades. The digital certificates may be used to ensure that the public key is the appropriate public key to decrypt the digital signature accompanying the software upgrade.

The method described above may be implemented in any suitable system. For example, the method may be implemented in a system having an encryption device configured to generate a digital signature for a software upgrade. The encryption device may be controlled by a manufacturer/distributor. The system further may include a transmission device configured to send a dispatch including the software upgrade and the digital signature. Such transmission device may be a user's computer or other suitable device adapted to transmit a dispatch over a wireless network. The system also may include a receiving device configured to receive the dispatch from the transmission device. The receiving device may further be configured to decrypt and validate the digital signature in the dispatch. The receiving device may accept the software upgrade when the decrypted digital signature matches a comparative message digest computed by the receiving device.

FIG. 4 further illustrates, generally at 50, the transmission of a software dispatch (such as new software or a software upgrade) to an image display system 54. As discussed above, the software dispatch may be coupled with a digital signature. The digital signature may be encrypted using a private key or like coding system. The image display system 54, in its most basic form, includes a processor 56 and memory 58.

Processor 56 may take the form of a central processing unit (CPU), or other suitable controller for controlling operation of the image display device and/or image-rendering device. Processor 56 thus may be configured to manage operation and function of the image display device and/or image-rendering device. For example, processor 56 may manage operational programs, menu programs, user-interface programs, image-rendering programs, network communications, etc.

Memory 58 may include both volatile memory and non-volatile memory. Non-volatile memory may be utilized to store permanent or semi-permanent data. Such non-volatile memory may be any suitable type of non-volatile memory, including, but not limited to, ROM, PROM, EPROM, EEPROM and Flash memory, and combinations thereof. Volatile memory may be utilized to store temporary data, including images and instructions. Volatile memory may include one or more suitable types of volatile memory, such as SRAM or DRAM.

Digital signature system 60 may be stored within memory 58. A digital signature system code may be included within the digital signature system 60 and may be stored in memory 58. Each of the algorithms, such as the public key and SHA-1 algorithms may be part of the digital signature system 60 and may be stored in memory 58.

Digital signature system 60 may be configured to decrypt and validate the digital signature accompanying the software dispatch. For example, processor 56 may use the digital signature system to compute a comparative message digest. The processor further may use the public key contained within memory 58 to decrypt the digital signature. The decrypted digital signature may be matched with the comparative message digest to identify whether the software dispatch is authentic unaltered software.

For illustrative purposes, and not as a limitation, processor 56 may run a public key algorithm, such as the RSA public key, to decrypt the received digital signature. After decrypting the digital signature, the digital signature system may be used to determine whether the decrypted digital signature matches the computed message digest. When the digital signature matches the computed message digest, a software upgrade may be identified as an authentic unmodified software upgrade. Once so identified, the authentic software upgrade may be introduced into the image display system to upgrade software 62 stored in memory 58.

Software upgrade may provide updates to any suitable software within the image display system. For example, software 62 may be provided within the image-rendering device to enable the device to convert and render prestored images into projectable images. Thus, in some embodiments, software 62 may be provided in the device to enable a prestored presentation to be presented with dynamic graphics and other animations. The software upgrade may enhance the operation of such software.

It should be appreciated that the software described above is for illustrative purposes only and other types of software and/or software updates may be included on the image-rendering device and/or the image display device. For example, the software may correspond to any one of a number of compressed video formats. Exemplary software upgrades may enhance the display of video transmitted in such formats. Any other suitable software or software upgrades are contemplated and within the scope of this disclosure.

Regardless of the type of software or the type of update, the use of the digital signature system prevents unauthorized software or software updates from being loaded on the image-rendering device or image display device. By preventing the downloading of unauthorized software or software updates, it may be possible to diminish the potential of introducing viruses, worms, Trojan horses, etc. into the image display system.

Although the above digital signature system for software upgrades is described in relationship to image display systems, it should be appreciated that such a system for securing software upgrades may be used in any suitable electronic device adapted to receive software upgrades over a communication link. For example, the digital signature system for software upgrades may be used to secure software upgrades (or other suitable software or programs) sent over a wireless network to a telephone, a personal data assistant, a computer, a home-entertainment system, etc.

In some embodiments, the above method, in full or in part, may be contained on a computer-readable medium. For example, instructions executable by a computing device to perform a method for use in identifying an authorized software upgrade may be contained on a computer-readable medium. Thus, in some embodiments, the instructions on the computer-readable medium may recite a method including receiving a software upgrade with a digital signature, decrypting the digital signature, validating the digital signature, and accepting the software upgrade where the digital signature is valid.

Although the present disclosure includes specific embodiments, specific embodiments are not to be considered in a limiting sense, because numerous variations are possible. The subject matter of the present disclosure includes all novel and nonobvious combinations and subcombinations of the various elements, features, functions, and/or properties disclosed herein. The following claims particularly point out certain combinations and subcombinations regarded as novel and nonobvious. These claims may refer to “an” element or “a first” element or the equivalent thereof. Such claims should be understood to include incorporation of one or more such elements, neither requiring, nor excluding two or more such elements. Other combinations and subcombinations of features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method of securing transmission of a software dispatch, the method comprising:
wirelessly receiving a software dispatch with a digital signature;
decrypting the digital signature;
validating the digital signature; and
if the digital signature is valid, accepting the software dispatch.

2. The method of claim 1, wherein receiving a software dispatch includes wirelessly receiving a software dispatch.

3. The method of claim 1, wherein decrypting the digital signature includes using a public key to decrypt the digital signature.

4. The method of claim 3, wherein the public key corresponds to a private key used to generate the digital signature.

5. The method of claim 3, wherein the public key is an RSA public key.

6. The method of claim 1, wherein prior to validating the digital signature, the method includes computing a comparative message digest.

7. The method of claim 6, wherein computing a comparative message digest is accomplished using a SHA-1 secure hash algorithm.

8. The method of claim 6, wherein validating the digital signature includes comparing the decrypted digital signature with the computed comparative message digest.

9. The method of claim 8, wherein the digital signature is valid when the decrypted digital signature matches the comparative message digest.

10. The method of claim 1 wherein the software dispatch is an image display software upgrade.

11. A system for securing software upgrades comprising:
an encryption device configured to generate a digital signature for a software upgrade;
a transmission device configured to send a dispatch including the software upgrade and the digital signature; and
a receiving device configured to receive the dispatch from the transmission device, the receiving device further configured to decrypt the digital signature in the dispatch,
wherein the receiving device accepts the software upgrade when the decrypted digital signature matches a comparative message digest computed by the receiving device.

12. The system of claim 11, wherein the receiving device is an image display system.

13. The system of claim 11, wherein the encryption device is configured to use a private key to form the digital signature.

14. The system of claim 11, wherein the transmission device is a user's computer.

15. The system of claim 11, wherein the receiving device is configured to decrypt the digital signature using a public key.

16. The system of claim 11, wherein the encryption device is configured to use a private key to form the digital signature and the receiving device is configured to decrypt the digital signature using a public key, wherein the public key corresponds to a private key used to generate the digital signature.

17. The system of claim 16, wherein the public key is an RSA public key.

18. The system of claim 11, wherein the comparative message digest is computed by using a SHA-1 secure hash algorithm

19. The system of claim 11, wherein the receiving device is configured to decrypt the digital signature and where the decrypted digital signature is compared with the comparative message digest.

20. The system of claim 19, wherein the digital signature is valid when the decrypted digital signature matches the comparative message digest.

21. An image display system linked to a transmission device and configured to receive a dispatch with a digital signature, the image display system comprising:
a processor; and
memory including a digital signature system, including a digital signature system code stored in memory;
wherein the processor is configured to decrypt the digital signature using the digital signature system, the processor further configured to accept the dispatch if the digital signature is valid.

22. The image display system of claim 21, wherein the digital signature system includes a public key used to decrypt the digital signature.

23. The image display system of claim 22, wherein the processor is configured to decrypt the digital signature using the public key.

24. The image display system of claim 22, wherein the public key corresponds to a private key used to generate the digital signature.

25. The image display system of claim 22, wherein the public key is an RSA public key.

26. The image display system of claim 23, wherein the processor is configured to compute a comparative message digest and compare the comparative message digest with the decrypted digital signature.

27. The image display system of claim 26, wherein the digital signature system includes the SHA-1 secure hash algorithm and the processor uses the SHA-1 secure has algorithm to compute the comparative message digest.

28. The image display system of claim 27, wherein the processor is configured to compare the comparative message digest and the decrypted digital signature to determine if there is a match indicating that the digital signature is valid.

29. The image display system of claim 21, wherein the dispatch is a software upgrade and the processor upon accepting the dispatch introduces the software upgrade to the image display system.

30. On a computer-readable storage medium, instructions executable by a computing device to perform a method for use in identifying an authorized software upgrade, the method comprising:
receiving a software upgrade with a digital signature;
decrypting the digital signature;
validating the digital signature; and
accepting the software upgrade where the digital signature is valid.

31. The method of claim 30, wherein decrypting the digital signature includes using a public key to decrypt the digital signature.

32. The method of claim 30, wherein prior to validating the digital signature, the method includes computing a comparative message digest.

33. The medium of claim 32, wherein validating the digital signature includes comparing the decrypted digital signature with the computed comparative message digest.

34. A method of securing a software upgrade, the method comprising:
generating a digital signature for the software upgrade using a private key;
distributing the software upgrade to a user; and
supplying a public key for use in decrypting the digital signature, the public key corresponding to the private key

35. The method of claim 34, wherein the software upgrade is for an image display system.
